(19) United States
(12) Patent Application Publication
(10) Pub. No.: US 2014/0208074 A1
(43) Pub. Date: Jul. 24, 2014

(54) INSTRUCTION SCHEDULING FOR A MULTI-STRAND OUT-OF-ORDER PROCESSOR

(71) Applicants: Boris A. Babayan, Moscow (RU); Vladimir Pentkovski, Folsom, CA (US); Jayesh Iyer, Bangalore (IN); Nikolay Kosarev, Yoshkar-Ola (RU); Sergey Y. Shishlov, Moscow (RU); Alexander V. Butuzov, Moscow (RU); Alexey Y. Sivtsov, Moscow (RU)

(72) Inventors: Boris A. Babayan, Moscow (RU); Vladimir Pentkovski, Folsom, CA (US); Jayesh Iyer, Bangalore (IN); Nikolay Kosarev, Yoshkar-Ola (RU); Sergey Y. Shishlov, Moscow (RU); Alexander V. Butuzov, Moscow (RU); Alexey Y. Sivtsov, Moscow (RU)

(21) Appl. No.: 13/993,552

(22) PCT Filed: Mar. 30, 2012
(86) PCT No.: PCT/US12/31474

§ 371 Date: Jun. 12, 2013

(51) Int. Cl. G06F 9/30

(52) U.S. Cl. CPC G06F 9/30145
USPC 712/206

(57) ABSTRACT

In one embodiment, a multi-strand system with a pipeline includes a front-end unit, an instruction scheduling unit (ISU), and a back-end unit. The front-end unit performs an out-of-order fetch of interdependent instructions queued using a front-end buffer. The ISU dedicates two hardware entries per strand for checking operand-readiness of an instruction and for determining an execution port to which the instruction is dispatched. The back-end unit receives instructions dispatched from the hardware device and stores the instructions until they are executed. Other embodiments are described and claimed.

### TECHNICAL FIELD

Embodiments of the invention relate to the scheduling of instructions for execution in a computer system having superscalar architecture.

### BACKGROUND ART

In traditional superscalar architectures, numerous instructions are fetched and decoded from an instruction stream at the same time. Typically, the fetch is performed in the order that instructions are found as programmed in source code (i.e., in-order fetch).

Once fetched and decoded, instructions are provided as input to an instruction scheduling unit (“ISU”). Having received the fetched instructions, the ISU stores the instructions in hardware structures (e.g., reservation queues which hold unexecuted instructions; reorder buffer holds instructions till they are retired) while the instructions wait to be dispatched, then executed, and finally retired. In scheduling the waiting instructions stored in its hardware structures, the ISU may, for example, dynamically re-order the instructions pursuant to scheduling considerations. Upon retirement, the instruction is no longer stored by the ISU's hardware (e.g., in reorder buffer).

The number of instructions in the ISU's hardware (e.g., the reorder buffer) at a given time is the ISU's “instruction scheduling window.” In other words, the instruction scheduling window ranges from the oldest instruction executed but not yet retired to the newest instruction not yet executed (e.g., residing in reservation station). The maximum number of instructions that may be dispatched during any single clock cycle is the ISU's “execution width.” To achieve greater throughput for the machine, i.e. a wider execution width, a larger instruction scheduling window is necessary. However, a linear increase in execution width requires a quadratic increase in the instruction scheduling window. Moreover, a linear increase in the size of instruction scheduling window requires a linear increase in the size of ISU hardware structures. Thus, to achieve liner increase in execution width, there needs to be a quadratic increase in the size of ISU hardware structures (e.g., reservation station). Increases in the size of ISU hardware structures comes at a cost, as additional hardware structures require additional physical space inside the ISU and additional computing resources (e.g., processing, power, etc) for their management.

### BRIEF DESCRIPTION OF THE DRAWINGS

FIG. 1 is a block diagram of a system in accordance with an embodiment of the invention

FIG. 2 is a flow diagram of a method in accordance with an embodiment of the invention.

FIGS. 3a-3h illustrate use of a system in accordance with an embodiment of the invention.

FIG. 4 is a block diagram of a processor core in accordance with an embodiment of the invention.

FIG. 5 is a block diagram of a system in accordance with an embodiment of the invention.

### DESCRIPTION OF THE EMBODIMENTS

Instructions in a superscalar architecture may be fetched, pipelined in the ISU, and executed as grouped in strands. A strand is a sequence of interdependent instructions that are data-dependent upon each other. For example, a strand including instruction A, instruction B, and instruction C may require a particular execution order if the result of instruction A is necessary for evaluating instructions B and C. Because the instructions of each strand are interdependent, superscalar architectures may execute numerous strands in parallel. As such, the instructions of a second strand may outrun the instructions of a first strand even though the location of first strand instructions may precede the location of second strand instructions in the original source code.

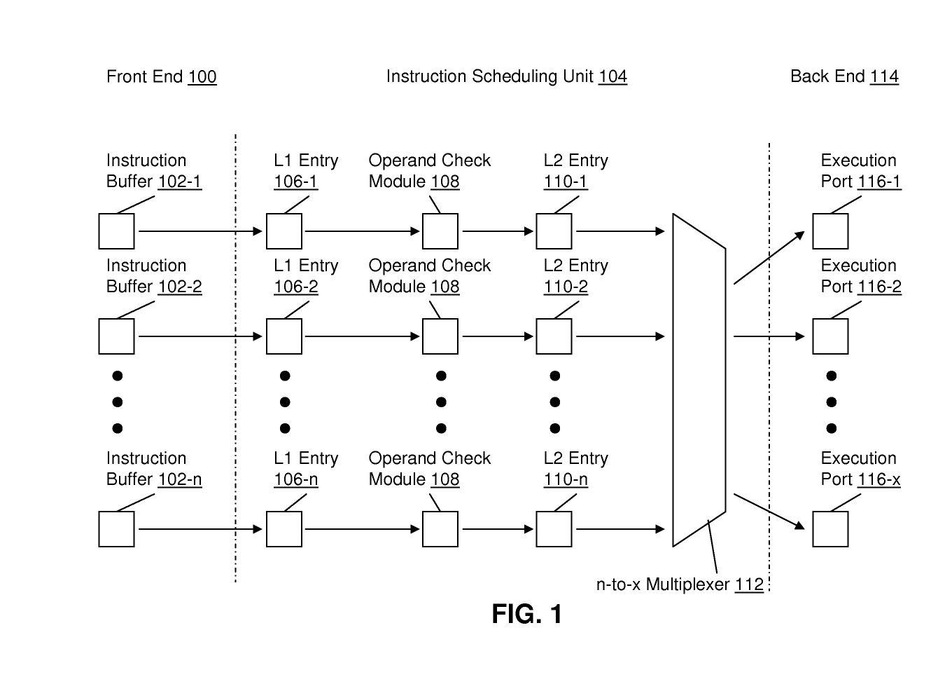

Referring now to FIG. 1, shown is a block diagram of a system in accordance with an embodiment of the invention. Shown is an instruction scheduling unit (ISU) 104 in relation to a front-end unit 100 and back-end unit 114. The front-end unit 100 and back-end unit 100 are coupled to the ISU 104.

In accordance with embodiments of the invention, the front-end unit 100 includes numerous instruction buffers, e.g., 102-1 through 102-n, for receiving fetched instructions. The instruction buffers may be implemented using a queue (e.g., FIFO queue) or any other container-type data structure. Instructions stored in an instruction buffer may be ordered based on an execution order.

Further, in accordance with one or more embodiments of the invention, each instruction buffer, e.g., 102-1 through 102-n, may uniquely correspond with a fetched strand of instructions. Accordingly, instructions stored in each buffer may be interdependent. In such embodiments, instructions may be buffered in an execution order that respects the data dependencies among the instructions of the strand. For example, a result of executing a first instruction of a strand may be required to evaluate a second instruction of the strand. As such, the first instruction will precede the second instruction in an instruction buffer dedicated for the strand. In such embodiments, an instruction stored in a head of a buffer may be designated as the first or next instruction for dispatching and executing.

In accordance with embodiments of the invention, the ISU 104 may receive an instruction from an instruction buffer, e.g., 102-1 through 102-n, as its input. As shown in FIG. 1, the ISU 104 includes a first level of hardware entries, e.g., 106-1 through 106-n, and a second level of hardware entries, e.g., 110-1 through 110-n, for storing instructions. The aforementioned hardware entries may include but is not limited to hardware buffers, flops, or any other hardware resource capable of storing instructions and/or data.

As further shown in FIG. 1, the ISU 104 includes one or more modules 108 for checking operand readiness of instructions stored in the ISU. An operand check module 108 may take as its input an instruction stored in a first level hardware entry and determine whether the operands for the particular instruction are ready and if so moves the instruction to the corresponding entry in the second level of hardware entry (e.g., 110-n), so that the instruction may be considered for execution. In one or more embodiments of the invention, an operand check module 108 may be implemented using scoreboard logic. A scoreboard is a hardware table containing the instant status of a register or storage location in a machine implementing a multi-strand out-of-order processor. Each register or storage location provides the functionality to register and indicate the availability of the register to a consumer of the register's data. In one or more embodiments of the invention, the scoreboard logic in the ISU 104 may be implemented in combination with a tag comparison logic based on Content Addressable Memory (CAM) as discussed in U.S. patent application Ser. No. 13/175,619 (“Method and Apparatus for Scheduling of Instructions in a Multi-Strand Out-Of-Order Processor”).

As further shown in FIG. 1, the ISU 104 may include a multiplexer 112 in accordance with embodiments of the invention. A multiplexer 112 may take as its input one or more instructions stored in second level hardware entries and determine the availability of execution ports for those stored instructions. For example, a n-to-x multiplexer, as shown in FIG. 1, may be used to select up to x out of the n stored instructions and designate to the x execution ports. Once an execution port is designated as available for an operand-ready instruction stored in the second level hardware entry, the instruction is dispatched to the execution port. Alternatively, in one or more other embodiments of the invention, some other means may be used to select an execution port for an instruction stored in the ISU 104. In one or more embodiments of the invention, an instruction dispatch algorithm may be used to drive the multiplexer or other means of selecting an execution port.

The back-end 114 of the ISU 104 includes a number of execution ports, e.g., 116-1 through 116-x, to which operand-ready instructions stored in the ISU 104 are dispatched. Once an instruction is dispatched to an execution port, the instruction is ready for execution by an execution unit, then executed and then finally is retired.

In various embodiments of the invention involving a multi-strand superscalar architecture, certain features as shown in FIG. 1 are dedicated on a per strand basis. In such embodiments, a front-end instruction buffer, a first level hardware entry, an operand check module, and a second level hardware entry may be dedicated for each strand. For example, a first strand may be associated with a dedicated L1 entry 106-1, a dedicated L2 entry 110-1, and a dedicated operand check module 108 situated between them as shown in FIG. 1. Accordingly, these features may be used only with respect to instructions of the first strand. Likewise, a second strand may be associated with a dedicated L1 entry 106-2, a dedicated L2 entry 110-2, and a dedicated operand check module 108 that is situated between them.

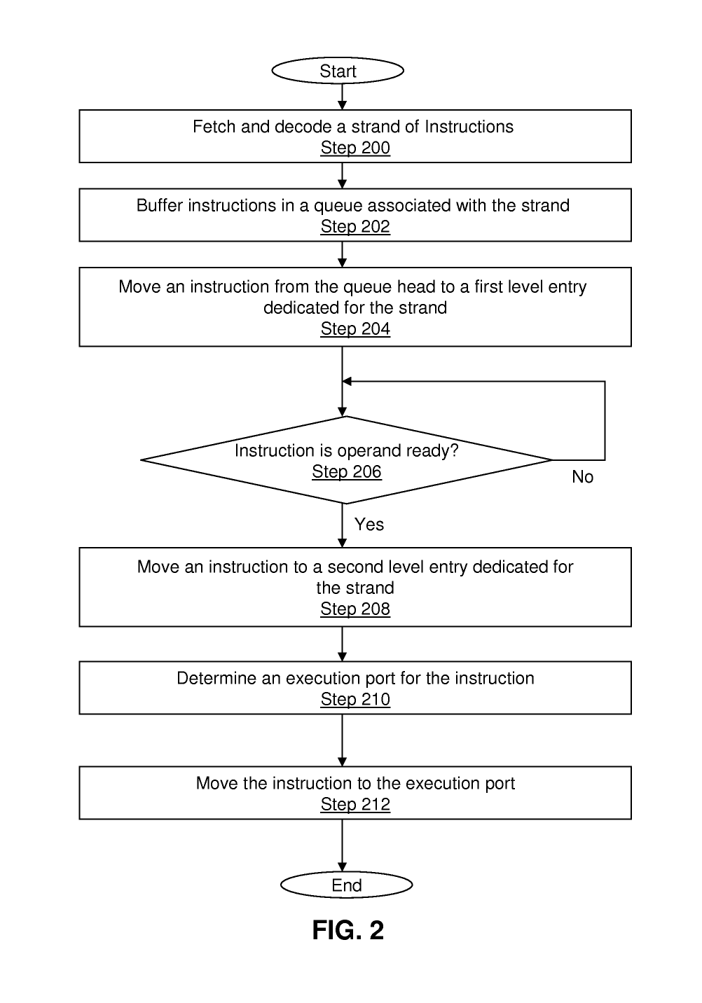

Referring now to FIG. 2, shown is a flow diagram of a method in accordance with an embodiment of the invention. The method shown in FIG. 2 may be performed by a system as described in relation to FIG. 1. Beginning with Step 200, a strand of instructions is fetched and decoded. The instructions of a strand may be interdependent in that there are some data dependencies among the instructions. In accordance with various embodiments of the invention, the fetch operation may be an out-of-order fetch with respect to where the fetched instructions are positioned in a source code.

In Step 202, the fetched instructions are buffered in a queue associated with the strand. The instructions may be interdependent and require buffering in a particular order. For example, interdependent instructions may be buffered in an execution order. In accordance with various embodiments of the invention, the execution order for the interdependent instructions of a particular strand may be determined based on data dependencies existing among the instructions.

In Step 204, an instruction from a head of the queue is moved to a first level hardware entry dedicated for the strand. In accordance with various embodiments of the invention, an instruction moved from a head of an ordered queue is the instruction that would be considered by the ISU for execution

In Step 206, a determination is made as to whether the instruction stored in the first level hardware entry is operand-ready for execution. For example, if the instruction was to add x and y and place the sum in z, an operand check determination would determine if x and y had already been evaluated. If x and y have already been evaluated, then the instruction is said to be operand-ready and Step 208 is performed next. However, if x and/or y have not been evaluated, the values for the add instruction are not yet determined and the instruction is therefore not operand-ready. If the instruction is not operand-ready, then waiting is required until operand-readiness is determined for the instruction.

In accordance with some embodiments of the invention, the operand check determination is performed using scoreboard logic and/or tag comparison logic or both as discussed in relation to FIG. 1.

In Step 208, the operand-ready instruction stored in the first level hardware entry is moved to a second level hardware entry. In accordance with various embodiments of the invention, both the first and second level hardware entries are dedicated for a common strand of instructions.

In Step 210, an execution port is determined to receive the instruction when the instruction is dispatched. In accordance with embodiments of the invention where the number of execution ports is less than the number of strands being processed, an instruction dispatching algorithm may be used to determine which of many operand-ready instructions stored in one of the many second level hardware entries is the next to be dispatched to an available execution port. Further, in such embodiments, a multiplexer may be used to perform the instruction dispatching function as described.

In Step 212, the instruction is moved from the second level hardware entry to an execution port and is therefore dispatched. Having been dispatched, the instruction will eventually be executed and is then considered retired. Dispatched instructions are no longer stored in the two level hardware structure of ISU.

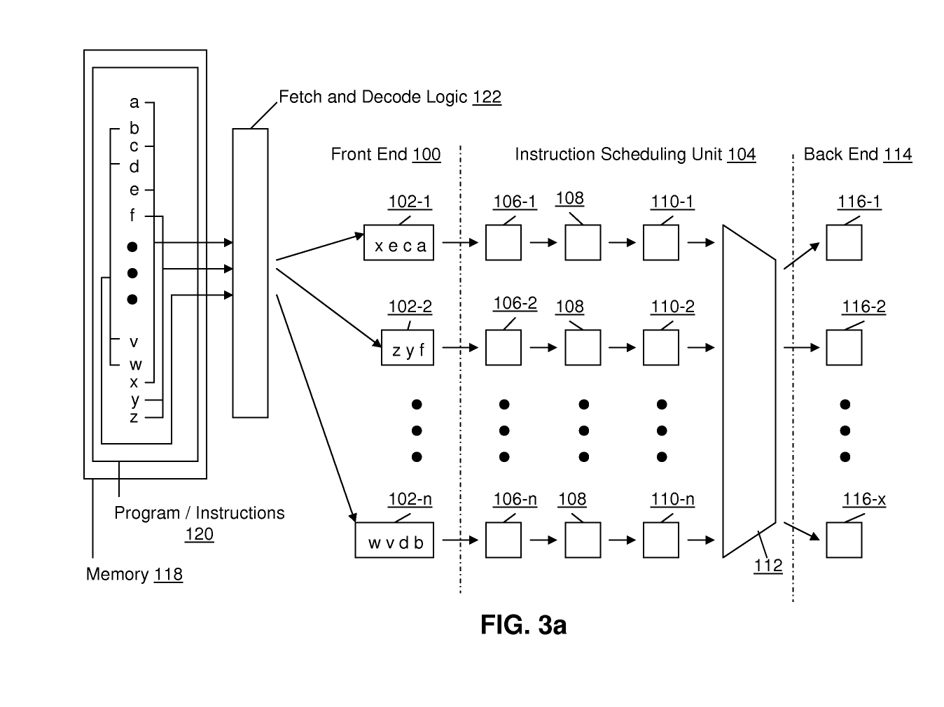

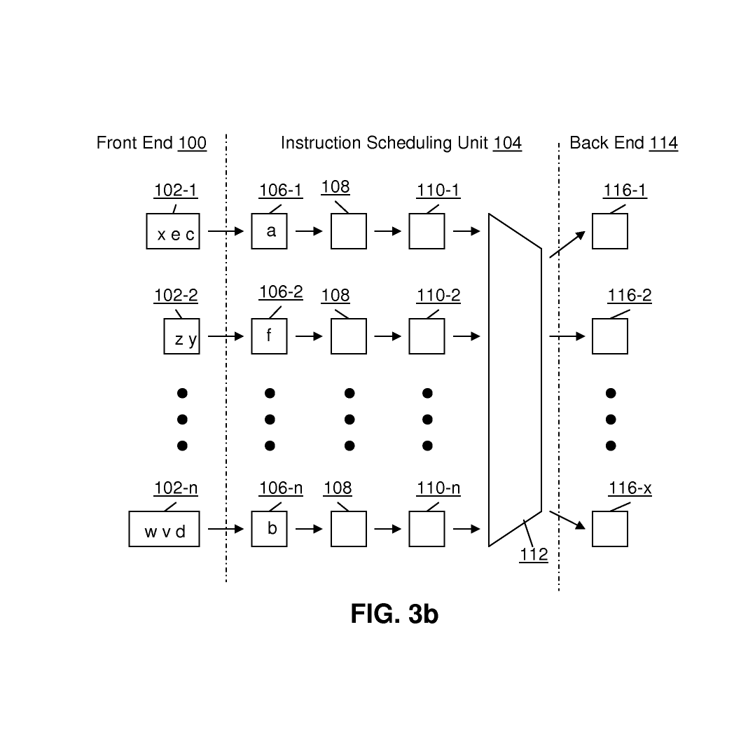

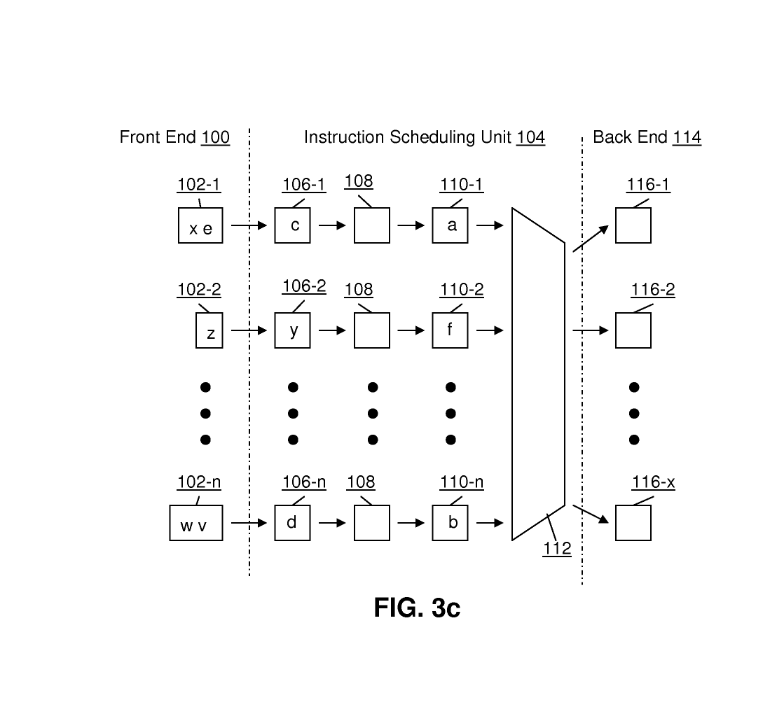

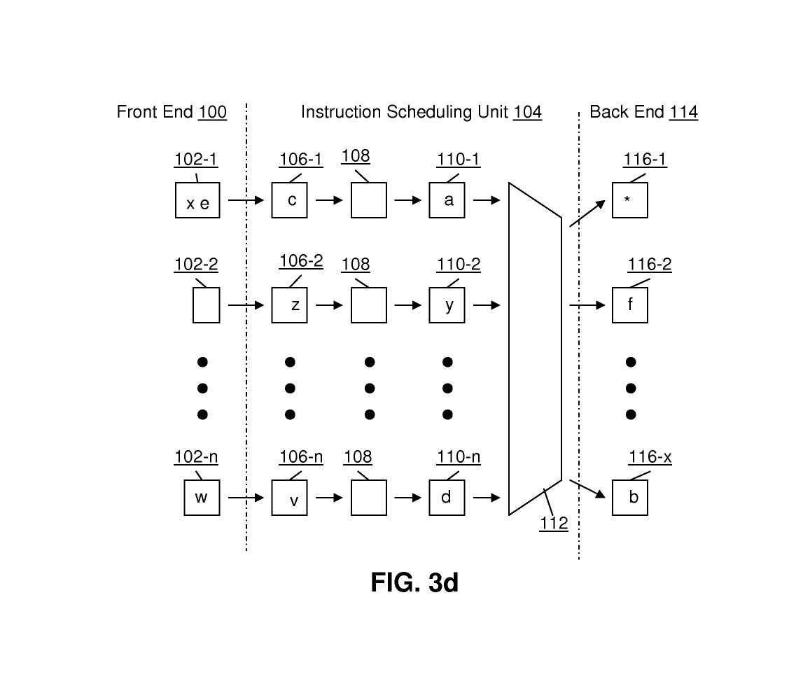

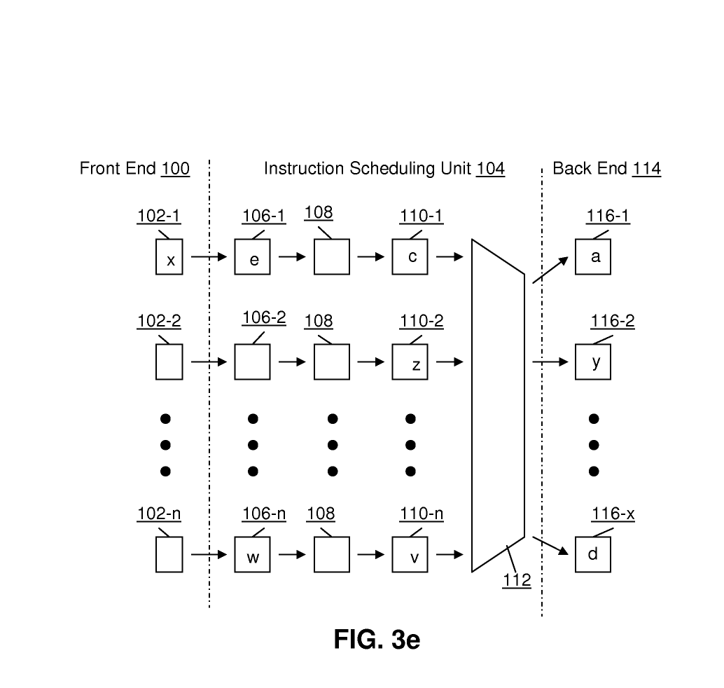

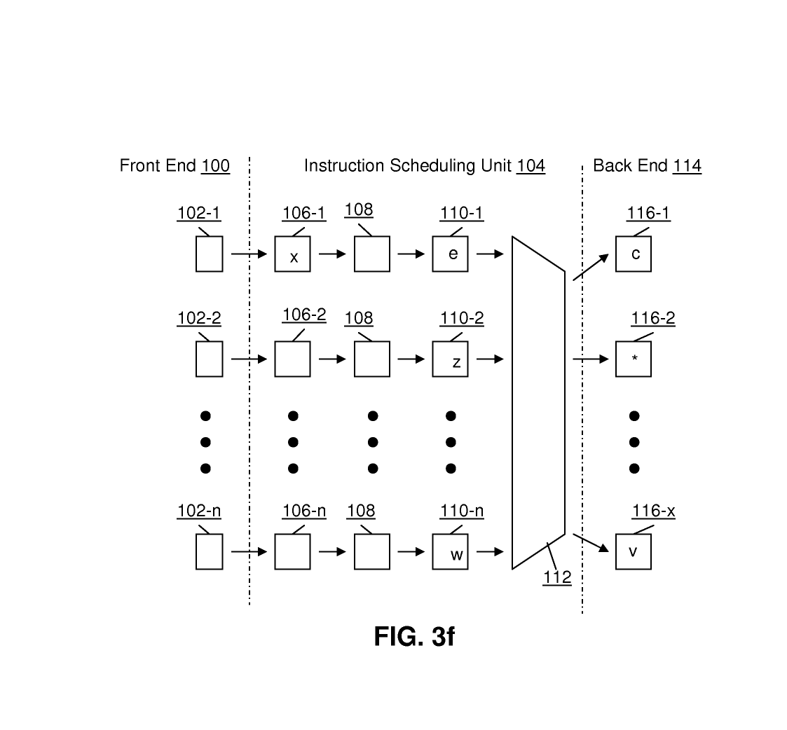

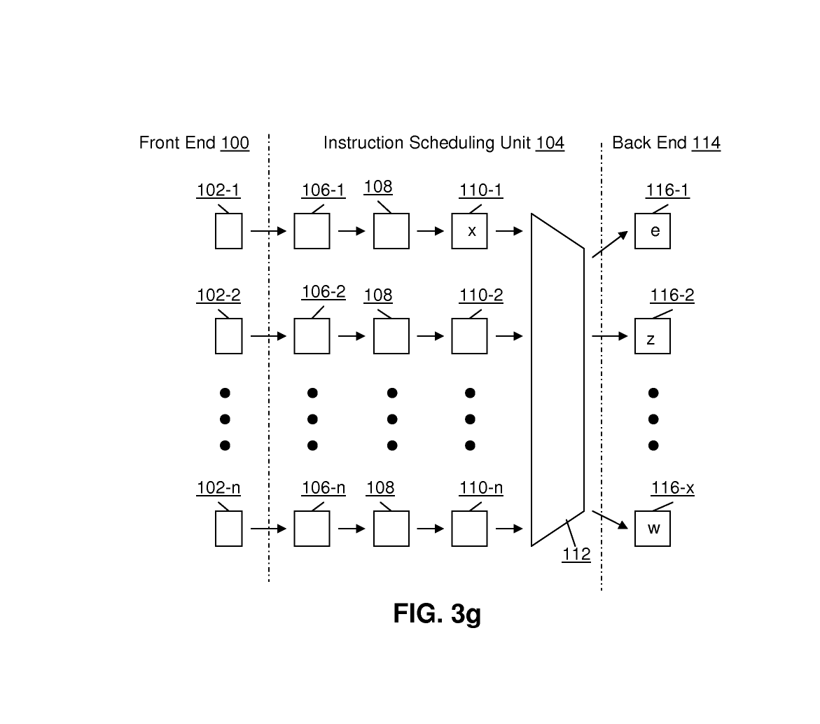

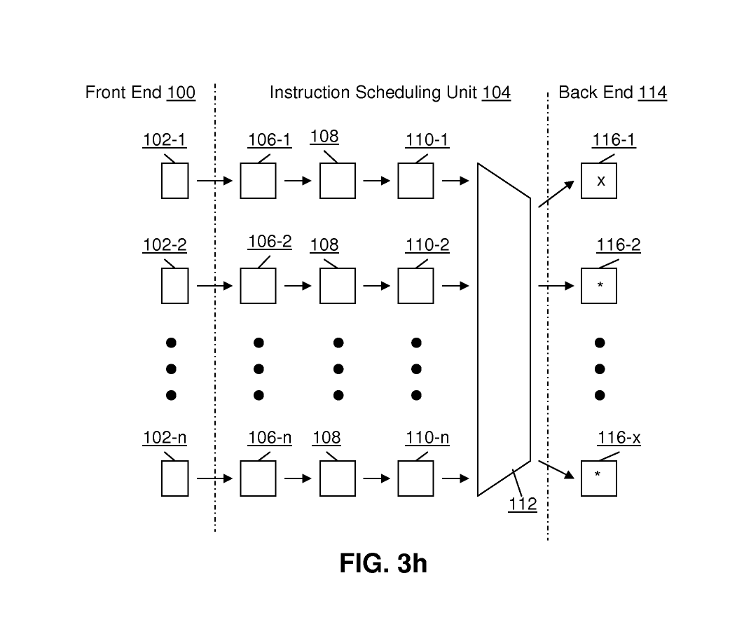

Referring now to FIGS. 3a-3h, shown is use of a system in accordance with an embodiment of the invention. The features shown in FIGS. 3a-3h include the same or similar features as discussed in relation to FIGS. 1 and 2. As such, the figures commonly show an instruction scheduling unit 104 (ISU) in relation to a front-end unit 100 and back-end unit 114.

Beginning with FIG. 3a, a memory device 118 is shown including a binary code 120 containing instructions stored therein. For purposes of example, the instructions are shown as a through z. Moreover, instructions of a common strand are indicated in the figure using brackets. As such, a first strand of interdependent instructions is: a, c, e, and x. A second strand of interdependent instructions is: f, y, and z. A third strand of interdependent instructions is: b, d, v, and w.

Further, for purposes of this example, assume that instructions in a particular strand with a later alphabetic indicator may have a data dependency with respect to an earlier alphabetic-indicated instruction. For example, in the first strand: instruction x is data-dependent upon one or more of instructions a, c, and e; instruction e depends on instructions a and/or c; instruction a possibly depends on instruction c; and instruction a does not depend on any other instruction.

Further shown in FIG. 3a, the instructions are fetched and decoded (e.g., via fetch and decode logic 122) on a per-strand basis and then buffered accordingly in the front-end unit 100 coupled to the ISU 104. As such, the first strand of interdependent instructions is buffered using a first instruction buffer 102-1, the second strand of interdependent instructions is buffered using a second instruction buffer 102-2, and the third strand of interdependent instructions is buffered using a third instruction buffer 102-n.

Moreover, the interdependent instructions in each strand are buffered in an execution order that respects the data dependencies existing among the instructions. For example, in the first instruction buffer 102-1, instruction a is shown at a head end of the buffer since instruction a does not depends on any other instruction in the strand. Instruction c may follow instruction a if instruction c depends only on instruction a. Alternatively, instruction c may simply follow instruction a and not depend on instruction a. Assume instruction e follows instructions a and c because instruction e may depend on instructions a and/or c. Assume instruction x follows instructions a, c, and e because instruction x may depend on instructions c, and/or e.

Turning to FIG. 3b, the first instruction of each strand is taken from the head of its respective instruction buffer and moved to a first level hardware entry corresponding with the strand. For example, instruction a is moved from the head of instruction buffer 102-1 and stored in first level hardware entry 106-1.

Turning to FIG. 3c, the instructions stored in the first level hardware entries have been checked for operand-readiness (e.g., using operand-check modules 108). As discussed above, instructions a, f, and b do not depend on any other instructions. As such, they are operand-ready and are appropriately moved from the first level hardware entries they previously occupied to a corresponding second level hardware entry, e.g., 110-1, 100-2, and 110-n.

In addition, FIG. 3c also shows that a next series of instructions c, y, and d are removed from the head of the depicted instruction buffers, e.g., 102-1, 102-2, and 102-n, and then moved to the first level hardware entries, e.g., 106-1, 106-2, and 106-n, left unoccupied by instructions a, f, and b.

Turning to FIG. 3d, the operand-ready instructions a, f, and b are provided as inputs into a multiplexer 112 for determining whether back-end execution ports, e.g., 116-1 through 116-x, are available. Subject to an instruction dispatch algorithm executed by the multiplexer 112, instructions f and b are selected for dispatch to execution ports 116-2 and 116-x respectively. Instructions y and d have been determined to be operand-ready and are therefore moved from their respective first level hardware entries, e.g., 106-2 and 106-n, to the corresponding second level hardware entries, e.g., 110-2 and 110-n, vacated by instructions f and b. In addition, instructions z and v are moved from the head of instruction buffers, e.g., 102-2 and 102-n, to the appropriate first level hardware entries, e.g., 106-2 and 106-n.

However, instruction a is not selected for dispatch to an available execution port and remains stored in the second level hardware entry 110-1. Rather, some other instruction (e.g., denoted by *) stored in some other second level hardware entry not depicted in FIG. 3d is selected for dispatch to second level hardware entry 116-1.

Turning to FIG. 3e, the instructions previously dispatched for execution in the depicted execution ports, e.g., 116-1, 116-2, and 116-n, have been executed and retired. Accordingly, the now-available execution ports have been provided with newly-dispatched instructions from the ISU 104. In this case, the newly-dispatched instructions are a, y, and d which were previously stored in the second level hardware entries, e.g., 110-1, 110-2, and 110-n, and have now been selected for dispatch by the multiplexer 112.

In addition, the instructions c, z, and v that were previously stored in the first level hardware entries, e.g., 106-1, 106-2, and 106-n, have been verified for operand-readiness and subsequently moved to the corresponding second level hardware entries, e.g., 110-1, 110-2, and 110-n. In the case of strands 1 and n, the instructions e and w that were stored in the head of the corresponding buffers, e.g., 102-1 and 102-n, have now been moved to the first level hardware entries vacated by instructions c and v. In the case of strand 2, the first level hardware entry 106-2 remains empty as there are no further instructions left in instruction buffer 102-2 to schedule and dispatch for the strand.

Turning to FIG. 3f, the instructions previously dispatched for execution in the depicted execution ports, e.g., 116-1, 116-2, and 116-n, have been executed and retired. Newly-dispatched instructions c and v have been moved from second level hardware entries 110-1 and 110-n to execution ports 116-1 and 116-x respectively. Further, some other instruction (e.g., denoted by *) stored in some other second level hardware entry not depicted in FIG. 3f is selected for dispatch to second level hardware entry 116-2.

In addition, the instructions e and w previously stored in the first level hardware entries 106-1 and 106-n, have been verified for operand-readiness and subsequently moved to the corresponding second level hardware entries 110-1 and 110-n. In the case of strand 1, the instructions x that was stored in the head of the instruction buffers 102-1 has now been moved to the first level hardware entry 106-1 vacated by instruction e. In the case of strand 3, the first level hardware entry 106-n remains empty because there are no further instructions left in instruction buffer 102-n to schedule and dispatch for the strand.

Turning to FIG. 3g, the instructions previously dispatched for execution in the depicted execution ports, e.g., 116-1, 116-2, and 116-n, have executed and been retired. Newly-dispatched instructions e, z, and w have been moved from the second level hardware entries, e.g., 110-1, 110-2, and 110-n to execution ports 116-1, 116-2, and 116-x respectively. In addition, instruction x previously stored in the first level hardware entry 106-1 has been verified for operand-readiness and subsequently moved to the corresponding second level hardware entry 110-2.

Turning to FIG. 3h, the instructions previously dispatched for execution in the depicted execution ports, e.g., 116-1, 116-2, and 116-n, have executed and been retired. Newly-dispatched instruction x has been moved from the second level hardware entry 110-1 to execution ports 116-1 respectively. At this time, the instruction scheduling unit 104 has scheduled and dispatched all the instructions from all of the fetched strands. Further, upon its execution, instruction x will be retired.

In view of FIGS. 1 and 3a-3h, the fixed two-level storage of waiting instructions in hardware inside the ISU allows for system scaling without a prohibitive cost. The use of queuing and ordered queuing in the front-end simplifies the hardware implementation of the ISU down to two levels (e.g., one level for operand-readiness and another level for determining execution port availability). As such, only two instructions per strand are stored in the ISU at any moment. In contrast, traditional ISU implementations are frequently tasked with maintaining the queuing and ordering of all waiting instructions, therefore requiring a processor-intensive and resource-costly design.

Size of hardware structures in ISU (first and second level hardware buffers, which is used for dynamic scheduling) scales linearly with respect to the execution width of the machine, as opposed to quadratic scaling of hardware resources (e.g. reservation station) in superscalar machines. This significantly reduces the complexity of the instruction scheduling unit (or the dynamic scheduler), thereby enabling to further increase execution width of out-of-order superscalar machines

As the size of hardware structures (first and second level hardware buffers) of the ISU scales linearly with respect to “execution width” of the machine, and as each hardware resource is occupied by the head instruction of the strand in a particular processor cycle, the area consumed by the set of multiplexers, which forward the instruction being allocated to freed hardware buffer entries (reservation station entries in commercial superscalar architectures), can be totally eliminated. In other words, as opposed to commercial superscalar processors, where each instruction can be forwarded to a subset of reservation stations (to several reservation station entries) depending on instruction fetch order, there is no need to forward the head instruction of the strand to a hardware buffer (e.g., first level of the hardware buffer) entry dedicated for instruction from a different strand. The head instruction of a strand is directly forwarded to freed hardware buffer entry dedicated for instruction of the strand only.

As such, due to the two-level bound, an increase in the ISU's execution width (e.g., the maximum number of instructions dispatched in any one clock cycle) requires only a linear increase in the number of resources as opposed to an increase of any higher order (e.g., quadratic). In comparison, a traditional ISU implementation would require an even greater instruction scheduling window involving greater computing resources to manage and greater space to support the additional hardware resources. Accordingly, scaling a system as described herein to accommodate a greater execution width does not come at prohibitive cost in terms of area required for additional hardware units and additional power and computing resources for managing the additional hardware.

As there is no set of multiplexers required by hardware buffer (e.g., first level) allocation logic, such constraints on the allocation logic, where an instruction can be forwarded only to a subset of RS and which limit performance of commercial superscalar processors, are not applicable for multi-strand processor with two level buffer implemented. Thus it allows increasing performance of the multi-strand processor in comparison with commercial superscalar machines. As the hardware buffer allocation multiplexers are removed from critical execution pipeline of an instruction, it helps to mitigate clock frequency/power implications as well.

As such, the system's dedication of hardware resources inside the ISU on a per-strand basis reduces the amount of multiplexing logic often found in traditional ISU implementations. Traditional ISU implementations require a layer of multiplexing logic to allocate or assign an incoming instruction to a waiting queue inside the ISU. However, the dedication scheme requires no such logic and spares an area cost in placing one or more additional multiplexers inside the ISU and a processing cost in managing the multiplexing logic.

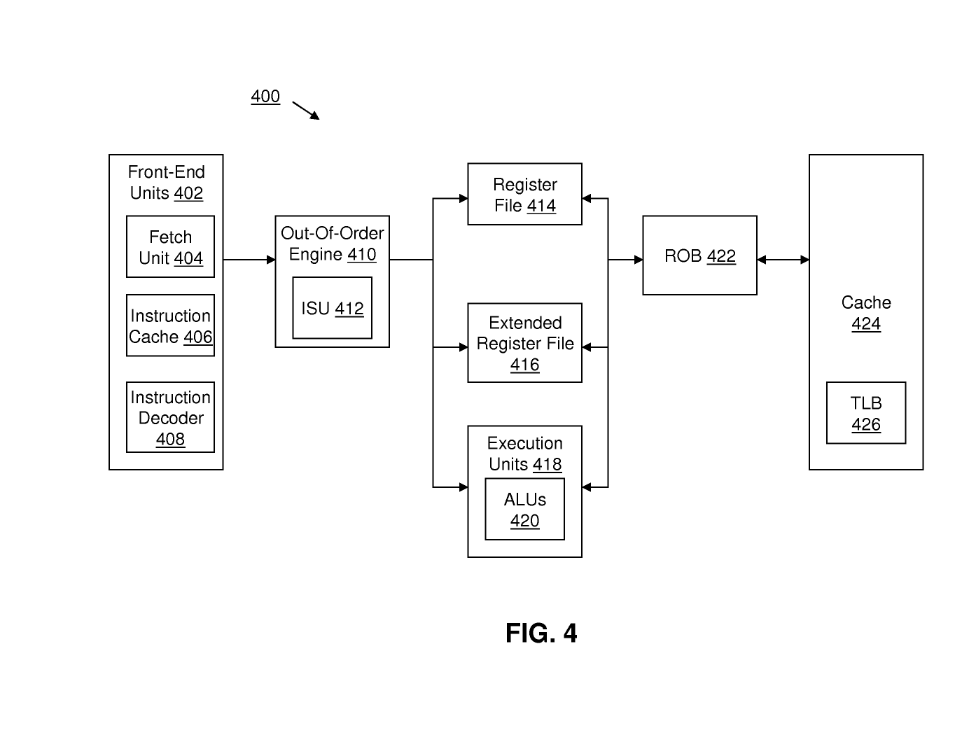

Embodiments can be implemented in many different processor types. For example, embodiments can be realized in a processor such as a multi-core processor. Referring now to FIG. 4, shown is a block diagram of a processor core in accordance with one embodiment of the present invention. As shown in FIG. 4, processor core 400 may be a multi-stage pipelined out-of-order processor. Processor core 400 is shown with a relatively simplified view in FIG. 4 to illustrate various features used in connection with scheduling instructions for dispatch and execution in accordance with an embodiment of the present invention.

As shown in FIG. 4, core 400 includes front-end units 402, which may be used to fetch instructions to be executed and prepare them for use later in the processor. For example, front-end units 402 may include a fetch unit 404, an instruction cache 424, and an instruction decoder 408. In some implementations, front-end units 402 may further include a trace cache, along with microcode storage as well as a micro-operation storage. Fetch unit 404 may fetch macro-instructions, e.g., from memory or instruction cache 406, and feed them to instruction decoder 408 to decode them into primitives such as micro-operations for execution by the processor.

Coupled between front-end units 402 and execution units 418 is an out-of-order (OOO) engine 410 that includes an instruction scheduling unit 412 (ISU) in accordance with various embodiments discussed herein. The ISU 412 that may be used to receive the micro-instructions and prepare them for execution as discussed in relation to FIGS. 1, 2, and 3a-3h. More specifically, OOO engine 410 may include various features (e.g., buffers, flops, registers, other hardware resources) to re-order micro-instruction flow and allocate various resources needed for execution, as well as to provide renaming of logical registers onto storage locations within various register files such as register file 414 and extended register file 416. Register file 414 may include separate register files for integer and floating point operations. Extended register file 416 may provide storage for vector-sized units, e.g., 256 or 512 bits per register.

Various resources may be present in execution units 418, including, for example, various integer, floating point, and single instruction multiple data (SIMD) logic units, among other specialized hardware. For example, such execution units may include one or more arithmetic logic units (ALUs) 420.

When operations are performed on data within the execution units, results may be provided to retirement logic, namely a reorder buffer (ROB) 422. More specifically, ROB 422 may include various arrays and logic to receive information associated with instructions that are executed. This information is then examined by ROB 422 to determine whether the instructions can be validly retired and result data committed to the architectural state of the processor, or whether one or more exceptions occurred that prevent a proper retirement of the instructions. Of course, ROB 422 may handle other operations associated with retirement.

As shown in FIG. 4, ROB 422 is coupled to cache 424 which, in one embodiment may be a low level cache (e.g., an L1 cache) and which may also include TLB 426, although the scope of the present invention is not limited in this regard. From cache 424, data communication may occur with higher level caches, system memory and so forth.

Note that while the implementation of the processor of FIG. 4 is with regard to an out-of-order machine, the scope of the present invention may be implemented in processors based on one or more instruction sets (e.g., x86, MIPS, RISC, etc) under the condition that the binary code in these instruction set architectures (ISAs) is modified by splitting instruction sequence into strands and adding relevant information like strand synchronization for scoreboard and program order information in the instruction format (e.g., before being fetched by the processor core).

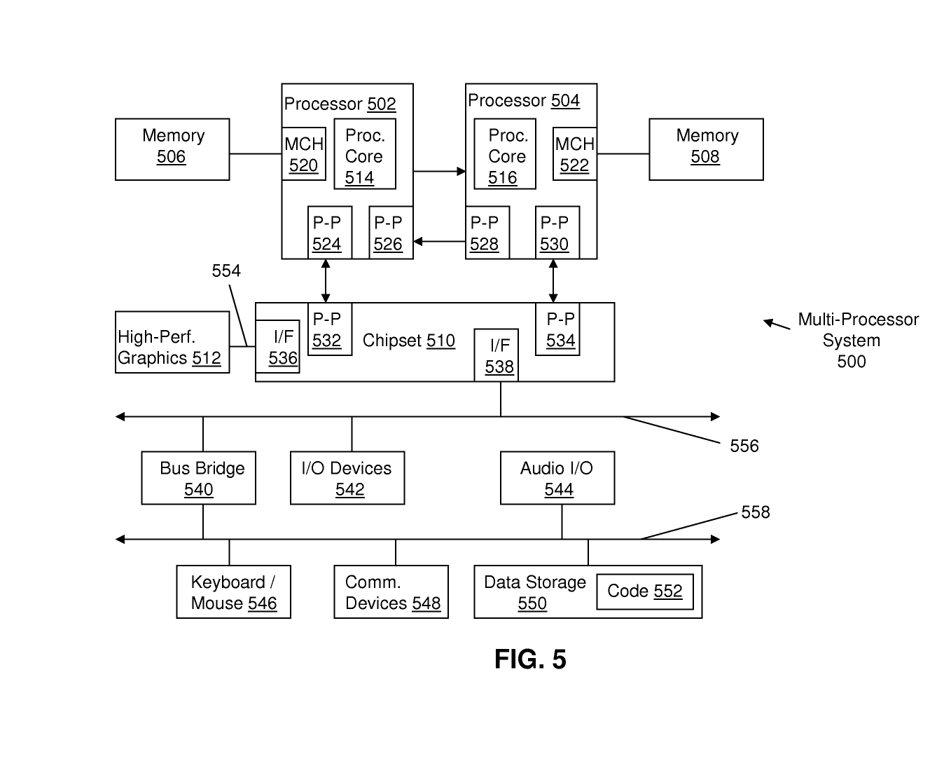

Referring now to FIG. 5, shown is a block diagram of a system in accordance with an embodiment of the present invention. As shown in FIG. 5, multiprocessor system 500 is a point-to-point interconnect system, and includes a first processor 502 and a second processor 504 coupled via a point-to-point interconnect. As shown in FIG. 5, each of processors 502 and 504 may be multicore processors, including first and second processor cores (i.e., processor cores 514 and 516), although potentially many more cores may be present in the processors. Each of the processors can include functionality for executing the instruction scheduling pipeline discussed in relation to FIGS. 1, 2, and 3a-3h and as otherwise discussed herein.

Still referring to FIG. 5, first processor 502 further includes a memory controller hub (MCH) 520 and point-to-point (P-P) interfaces 524 and 526. Similarly, second processor 504 includes a MCH 522 and P-P interfaces 528 and 530. As shown in FIG. 5, MCH's 520 and 522 couple the processors to respective memories, namely a memory 506 and a memory 508, which may be portions of system memory (e.g., DRAM) locally attached to the respective processors. First processor 502 and second processor 504 may be coupled to a chipset 510 via P-P interconnects 524 and 530, respectively. As shown in FIG. 5, chipset 510 includes P-P interfaces 532 and 534.

Furthermore, chipset 510 includes an interface 536 to couple chipset 510 with a high performance graphics engine 512 by a P-P interconnect 554. In turn, chipset 510 may be coupled to a first bus 556 via an interface 538. As shown in FIG. 5, various input/output (I/O) devices 542 may be coupled to first bus 556, along with a bus bridge 540 which couples first bus 556 to a second bus 558. Various devices may be coupled to second bus 558 including, for example, a keyboard/mouse 546, communication devices 548 and a data storage unit 550 such as a disk drive or other mass storage device which may include code 552, in one embodiment. Further, an audio I/O 544 may be coupled to second bus 558. Embodiments can be incorporated into other types of systems including mobile devices such as a smart cellular telephone, tablet computer, netbook, ultrabook, or so forth.

The following clauses and/or examples pertain to further embodiments:

One example embodiment may be a method including: fetching a strand of interdependent instructions for execution, wherein the strand of interdependent instructions are fetched out of order; dedicating a first hardware resource and a second hardware resource for the strand; storing an instruction of the strand using the first hardware resource; determining whether the instruction stored using the first hardware resource is operand-ready; storing the instruction using the second hardware resource when the instruction is operand-ready; and determining an available execution port for the instruction stored using the second hardware resource. The method may further include storing the fetched strand of interdependent instructions in a buffer with respect to execution order. The buffer may be in the front-end of an instruction scheduling unit for a multi-strand processor. The first hardware resource and the second hardware resource are inside of the instruction scheduling unit. Storing an instruction of the strand using the first hardware resource may include selecting the instruction from a head of the buffer and storing the instruction using the first hardware resource when the first hardware resource is empty. Determining whether the instruction stored in the first hardware resource is operand-ready may include performing an operand-ready check using one or more selected from the group consisting of scoreboard logic and tag comparison logic. The method may further include determining, using a multiplexer and an instruction dispatch algorithm, the available execution port for the instruction stored in the second hardware resource.

Another example embodiment may be a microcontroller executing in relation to an instruction scheduling unit to perform the above-described method.

Another example embodiment may be an apparatus for scheduling instructions for execution including a plurality of first level hardware entries to store instructions. The apparatus further includes a plurality of second level hardware entries to store instructions. The apparatus further includes a hardware module to determine whether an instruction stored in any one of the first level hardware entries is operand-ready. The apparatus may be coupled to a front-end unit. The front-end unit may fetch a plurality of strands of interdependent instructions. Each strand may be fetched out-of-order. The front-end unit may store each one of the fetched strands in one of a plurality of buffers in the front-end unit. The interdependent instructions stored in each one of the plurality of buffers may be ordered in each one of the plurality of buffers with respect to execution order. The apparatus may select an instruction from a head of one of the plurality of buffers and the store the instruction using a first hardware level entry from the plurality of first level hardware entries. Each one of the plurality of fetched strands may correspond with one of the plurality of first level hardware entries and one of the plurality of second level hardware entries. A first level hardware entry dedicated to a first strand of interdependent instructions and a second level hardware entry dedicate to the first strand of interdependent instructions may only store instructions associated with the first strand. The hardware module may determine whether an instruction stored in any one of the first level hardware entries is operand-ready by using one or more selected from the group consisting of scoreboard logic and tag comparison logic. The apparatus may include a multiplexer to select instructions stored in any one of the second level hardware entries for dispatching to execution ports. The multiplexer may dispatch an instruction stored in one of the second level hardware entries to an available execution port when the available execution port is determined for the instruction using an instruction dispatch algorithm. The hardware module may move an instruction stored using one of the plurality of first level hardware entries to one of the plurality of second level hardware entries when the instruction is determined operand-ready. One of the plurality of first level hardware entries and one of the plurality of second level hardware entries may be both dedicated to a common strand fetched by the front-end unit. The available execution port may be in a back-end unit coupled to the apparatus.

Another example embodiment may be a system including a dynamic random access memory (DRAM) coupled to a multi-core processor. The system includes the multi-core processor, with each core having at least one execution unit and an instruction scheduling unit. The instruction scheduling unit may include a plurality of first level hardware entries to store instructions. The instruction scheduling unit may include a plurality of second level hardware entries to store instructions. The instruction scheduling unit may include a hardware module to determine whether an instruction stored in any one of the plurality of first level hardware entries is operand-ready. The instruction scheduling unit may be coupled to a front-end unit comprising a plurality of buffers. The front-end unit may fetch a plurality of strands of interdependent instructions where each strand is fetched out-of-order. The front-end unit may store each one of the plurality of strands in one of the plurality of buffers with respect to execution order. The instruction scheduling unit may select an instruction from a head of one of the plurality of buffers and store the instruction using a first level hardware entry of the plurality of first level hardware entries. Each one of the plurality of fetched strands may correspond with one of the plurality of first level hardware entries and one of the plurality of second level hardware entries. The hardware module may determine whether an instruction stored in any one of the first level hardware entries is operand-ready by using one or more selected from the group consisting of scoreboard logic and tag comparison logic. The instruction scheduling unit may include a multiplexer to determine an available execution port for any instruction stored in any one of the second level hardware entries based on an instruction dispatch algorithm. The hardware module may move an instruction stored using one of the plurality of first level hardware entries to one of the plurality of second level hardware entries when the instruction is determined operand-ready. Each one of the plurality of buffers may be dedicated to a strand of interdependent instructions fetched by the front-end unit.

Another example embodiment may be an apparatus to perform the above-described method.

Another example embodiment may be a communication device arranged to perform the above-described method.

Another example embodiment may be at least one machine readable medium comprising instructions that in response to being executed on a computing device, cause the computing device to carry out the above-described method.

Embodiments may be implemented in code and may be stored on a non-transitory storage medium (e.g., machine-readable storage medium) having stored thereon instructions which can be used to program a system to perform the instructions. The storage medium may include, but is not limited to, any type of disk including floppy disks, optical disks, solid state drives (SSDs), compact disk read-only memories (CD-ROMs), compact disk rewritables (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), magnetic or optical cards, or any other type of media suitable for storing electronic instructions. Moreover, the embodiments may be implemented in code as stored in a microcontroller for a hardware device (e.g., an instruction scheduling unit).

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method, comprising:
fetching a strand of interdependent instructions for execution, wherein the strand of interdependent instructions are fetched out of order;
dedicating a first hardware resource and a second hardware resource for the strand;
storing an instruction of the strand using the first hardware resource;
determining whether the instruction stored using the first hardware resource is operand-ready;
storing the instruction using the second hardware resource when the instruction is operand-ready; and
determining an available execution port for the instruction stored using the second hardware resource.

2. The method of claim 1, further comprising:
storing the fetched strand of interdependent instructions in a buffer with respect to execution order.

3. The method of claim 2, wherein the buffer is in the front-end of an instruction scheduling unit for a multi-strand processor, and wherein the first hardware resource and the second hardware resource are inside of the instruction scheduling unit.

4. The method of claim 2, wherein storing an instruction of the strand using the first hardware resource comprises:
selecting the instruction from a head of the buffer; and
storing the instruction using the first hardware resource when the first hardware resource is empty.

5. The method of claim 1, wherein determining whether the instruction stored in the first hardware resource is operand-ready comprises:
performing an operand-ready check using one or more selected from the group consisting of scoreboard logic and tag comparison logic.

6. The method of claim 1, further comprising:
determining, using a multiplexer and an instruction dispatch algorithm, the available execution port for the instruction stored in the second hardware resource.

7. (canceled)

8. An apparatus for scheduling instructions for execution, comprising:
a plurality of first level hardware entries to store instructions;
a plurality of second level hardware entries to store instructions; and
a hardware module to determine whether an instruction stored in any one of the first level hardware entries is operand-ready.

9. The apparatus of claim 8, wherein the apparatus is coupled to a front-end unit, the front-end unit to:
fetch a plurality of strands of interdependent instructions, wherein each strand is fetched out-of-order; and
store each one of the fetched strands in one of a plurality of buffers in the front-end unit.

10. The apparatus of claim 9, wherein the interdependent instructions stored in each one of the plurality of buffers are ordered in each one of the plurality of buffers with respect to execution order.

11. The apparatus of claim 9, the apparatus to:
select an instruction from a head of one of the plurality of buffers; and
store the instruction using a first hardware level entry from the plurality of first level hardware entries.

12. The apparatus of claim 9, wherein each one of the plurality of fetched strands corresponds with one of the plurality of first level hardware entries and one of the plurality of second level hardware entries.

13. The apparatus of claim 12, wherein a first level hardware entry dedicated to a first strand of interdependent instructions and a second level hardware entry dedicated to the first strand of interdependent instructions only store instructions associated with the first strand.

14. The apparatus of claim 8, wherein the hardware module is to determine whether an instruction stored in any one of the first level hardware entries is operand-ready by using one or more selected from the group consisting of scoreboard logic and tag comparison logic.

15. The apparatus of claim 8, further comprising:
a multiplexer to select instructions stored in any one of the second level hardware entries for dispatching to execution ports.

16. The apparatus of claim 15, wherein the multiplexer is further to dispatch an instruction stored in one of the second level hardware entries to an available execution port when the available execution port is determined for the instruction using an instruction dispatch algorithm.

17. The apparatus of claim 8, wherein the hardware module is further to move an instruction stored using one of the plurality of first level hardware entries to one of the plurality of second level hardware entries when the instruction is determined operand-ready.

18. The apparatus of claim 17, wherein the one of the plurality of first level hardware entries and the one of the plurality of second level hardware entries are both dedicated to a common strand fetched by the front-end unit.

19. (canceled)

20. A system, comprising:
a dynamic random access memory (DRAM) coupled to a multi-core processor;
the multi-core processor, each core having at least one execution unit and an instruction scheduling unit, the instruction scheduling unit comprising:
a plurality of first level hardware entries to store instructions;
a plurality of second level hardware entries to store instructions; and
a hardware module to determine whether an instruction stored in any one of the plurality of first level hardware entries is operand-ready.

21. The system of claim 20, wherein the instruction scheduling unit is coupled to a front-end unit comprising a plurality of buffers, the front-end unit to:
fetch a plurality of strands of interdependent instructions, wherein each strand is fetched out-of-order; and
store each one of the plurality of strands in one of the plurality of buffers with respect to execution order.

22. The system of claim 21, the instruction scheduling unit to:
select an instruction from a head of one of the plurality of buffers; and
store the instruction using a first hardware level entry of the plurality of first level hardware entries.

23. (canceled)

24. (canceled)

25. (canceled)

26. (canceled)

27. (canceled)

28. (canceled)

29. (canceled)

30. (canceled)
